(19) United States
(12) Patent Application Publication
(10) Pub. No.: US 2012/0247988 A1
(43) Pub. Date: Oct. 4, 2012

(54) Merchandise Storage Container

(76) Inventors: Daniel A. Lax, New York, NY (US); Timothy J. Keuning, Northport, NY (US); Agjah I. Libohova, East Setauket, NY (US)

(21) Appl. No.: 13/386,900

(22) PCT Filed: Jul. 23, 2010
(86) PCT No.: PCT/US2010/043141

§ 371 Date: Jun. 11, 2012

Related U.S. Application Data
(60) Provisional application No. 61/228,468, filed on Jul. 24, 2009.
(60) Provisional application No. 61/263,969, filed on Nov. 24, 2009.
(60) Provisional application No. 61/320,586, filed on Apr. 2, 2010.

(51) Int. Cl. G11B 23/03; B29C 67/00; B65D 85/57

(52) U.S. Cl. 206/308.1; 206/525; 264/250

(57) ABSTRACT

A merchandise storage container includes a merchandise holder that holds the merchandise with respect to a container body. The merchandise holder is fabricated from one material that is generally robust while the remaining portions of the container are fabricated from a material that is weaker and may be a recycled material. On configuration of the invention holds media discs with a holder having a disc hub at one end and an edge release tab at its other end. The disc holder is secured to a recyclable container body that defines at least a portion of the disc nest.

### CROSS REFERENCE TO RELATED APPLICATIONS

This application claims the benefit of U.S. Provisional Patent Application Ser. Nos. 61/228,468 filed Jul. 24, 2009, 61/263,969 filed Nov. 24, 2009, and 61/320,586 filed Apr. 2, 2010; the disclosures of all three are incorporated herein by reference.

### BACKGROUND OF THE INVENTION

1. Technical Field

This invention generally relates to containers and, more particularly, to merchandise storage containers that are used to deliver the merchandise to the customers. The exemplary configurations of the invention are described with respect to the field of media disc storage containers. Specifically, the present disclosure relates to a tray for holding a media disc and, more particularly, to a tray for holding a media disc that includes both biodegradable and recyclable materials.

2. Background Information

Various merchandise storage containers are known in the art. Some of the most common storage containers for recorded media discs are injection molded, plastic book-like containers having a lid connected to a base with a pair of living hinges. These containers typically allow a printed promotional slip sheet to be carried between the lid/hinge/base and a transparent cover that defines a pocket. This arrangement allows the molded container to be used for a different media discs by adding printed material specific to the media disc to the container. The most popular types of these containers include some form of a media disc hub that engages the central opening of the media disc to secure the disc within the container. A wide variety of these hubs exist including passive and active pluck-off hubs and push button hubs. A variety of security locks are provided for these containers.

A drawback with these molded containers is the overall weight and the volume of plastic used in the container. As the industry moves towards more recyclable containers and containers that use fewer materials and energy during their manufacture, container consumers wish to reduce the amount of plastic in their containers as well as making the containers more recyclable. Ecologically sustainable products and manufacturing methods have become increasingly popular in today's marketplace. Not only are such products popular with consumers, but recent improvements in materials allow manufacturers to be environmentally friendly while still providing durable and reliable products. One problem with forming containers out of recycled material is that the holding features for the merchandise must be robust or the merchandise will release from the holder increasing the chance that the merchandise will break. In the field of media disc packaging, disc hubs manufactured from recycled materials have experienced a higher failure rate than traditional hubs made from virgin materials.

One example of such a sustainable product is a media tray that can be used to store and transport data media, such as optical discs. The product is made of an organic starch based material in place of the traditional petroleum based plastic commonly used in such trays. One problem with such trays has been providing a durable and flexible hub suitable for reliably retaining the optical discs in place in the tray. While biodegradable starch resins are available and have been used to make such flexible hubs, these hubs have generally provided poor results, especially during shipping. That is, the hubs fail and allow the media to shift and move in the trays during shipping, which often results in damage.

Accordingly, it would be beneficial to provide a sustainable tray for storing and transporting data media that avoids the problems described above.

### SUMMARY OF THE INVENTION

The invention provides a container wherein the features of the container that hold and protect the merchandise are fabricated from one material that is generally robust while the remaining portions of the container are fabricated from a material that is weaker and may be a recycled material.

One configuration of the invention provides a merchandise storage container that combines a minimal recyclable plastic storage holder with recyclable-paper-based container body. In one configuration, the majority of the minimal holder is disposed under a portion of the paper-based body out of the sight of the user. The feature or features that hold the merchandise protrude up through the portion of the paper-based body that covers most of the minimal holder.

Another configuration of the invention provides a merchandise storage container that combines a minimal recyclable plastic storage holder combined with a recyclable container body. The holder and container are made from different materials suitable for their purposes. The holder uses a material having properties desirable for holding the merchandise. The container uses a material that is generally less expensive than the material of the holder and may be a recycled material.

One configuration of the invention provides a sustainable tray for storing data media that is made of a biodegradable material and includes a durable and flexible hub portion such as one made of plastic for retaining the data media.

In one configuration, the two elements are joined together during the molding of one of the elements. The invention also provides a method for making the container wherein the holder is molded directly to the container body.

Another aspect of the invention is the structure and arrangement of the holder and the manner in which it cooperates with the body of the container.

Another aspect of the invention is the manner in which the holder is secured to the body of the container.

Another aspect of the invention is the structure of a disc hub that is used to hold a media disc in the container.

Another aspect of the invention is the combination and arrangement of the disc hub with a push tab that engages the outer edge of the disc.

The different aspects of the invention may be used individually or in combination.

### BRIEF DESCRIPTION OF THE DRAWINGS

FIG. 1 is a perspective view of a first configuration of the container with the lid closed.

FIG. 2 is a perspective view of the first configuration of the container with the lid open.

FIG. 3 is a top plan view of the inner panel closed over the inner surface of the base panel showing the openings that are defined by the inner panel in order to accommodate the merchandise holder.

FIG. 4 is a perspective view of a first configuration of a merchandise holder used with the first configuration of the container.

FIG. 5 is a top plan view of the first configuration of the merchandise holder.

FIG. 6 is an enlarged top plan view of a disc retention hub used with the first configuration of the merchandise holder.

FIG. 7 is a perspective view of the top of a second configuration of the container.

FIG. 8 is a perspective view of the bottom of the second configuration of the container.

FIG. 9 is a top plan view of the container.

FIG. 10 is a section view taken along line 10-10 of FIG. 9.

FIG. 11 is a view similar to FIG. 8 with the merchandise holder removed to show the container body.

FIG. 12 is a transparent view showing the connection between the holder and the container body.

FIG. 13 is top perspective view of a third configuration of the merchandise container showing a media disc being retained by the merchandise holder.

FIG. 14 is a view similar to FIG. 13 with the media disc removed.

FIG. 15 is a perspective view of the merchandise holder from FIGS. 13-14.

FIG. 16 is a rear perspective view of the container body from FIGS. 13-14.

FIG. 17 is a rear perspective view of FIG. 14.

FIG. 18 is a top plan view of FIG. 13.

FIG. 19 is a section view taken along line 19-19 of FIG. 18.

Similar numbers refer to similar parts throughout the specification.

### DETAILED DESCRIPTION OF THE INVENTION

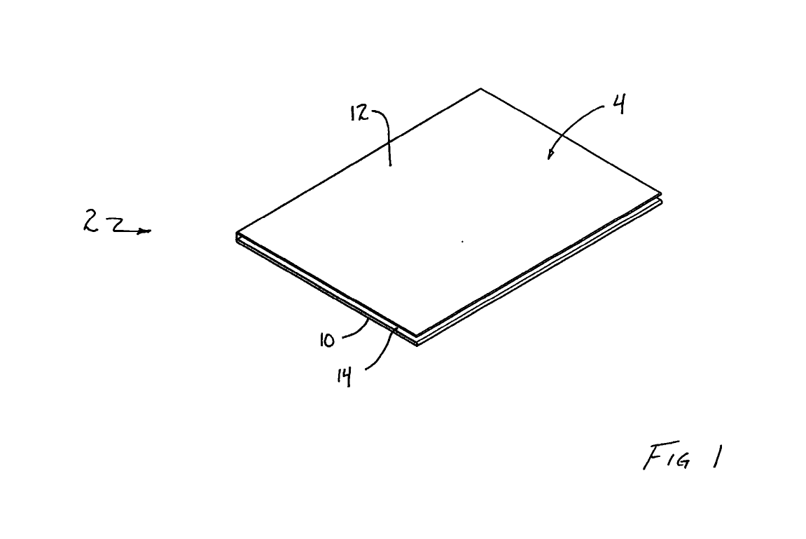

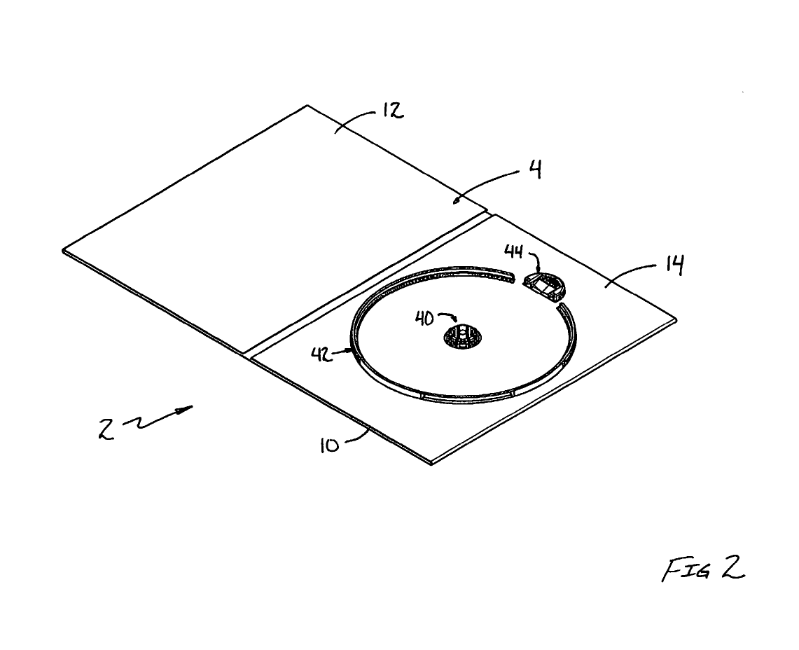

A first configuration of the container is indicated generally by the numeral 2 in the accompany drawings. Container 2 generally includes a container body 4 that is defined by a base panel 10, a lid panel 12, and an inner panel 14. When container 2 is closed as shown in FIG. 1, inner panel 14 is folded against base panel 10 and lid panel 12 is folded over the top of the outer surface of inner panel 14. As shown in FIG. 2, lid 12 may be moved to an open configuration to expose the outer surface of inner panel 14. As also shown in FIG. 2, lid 12 may itself be fabricated from an outer panel and an inner panel. In an alternative configuration of container 2, lid 12 may be configured similar to base 10 and inner panel 14 so that a second item of merchandise may be carried by lid 12.

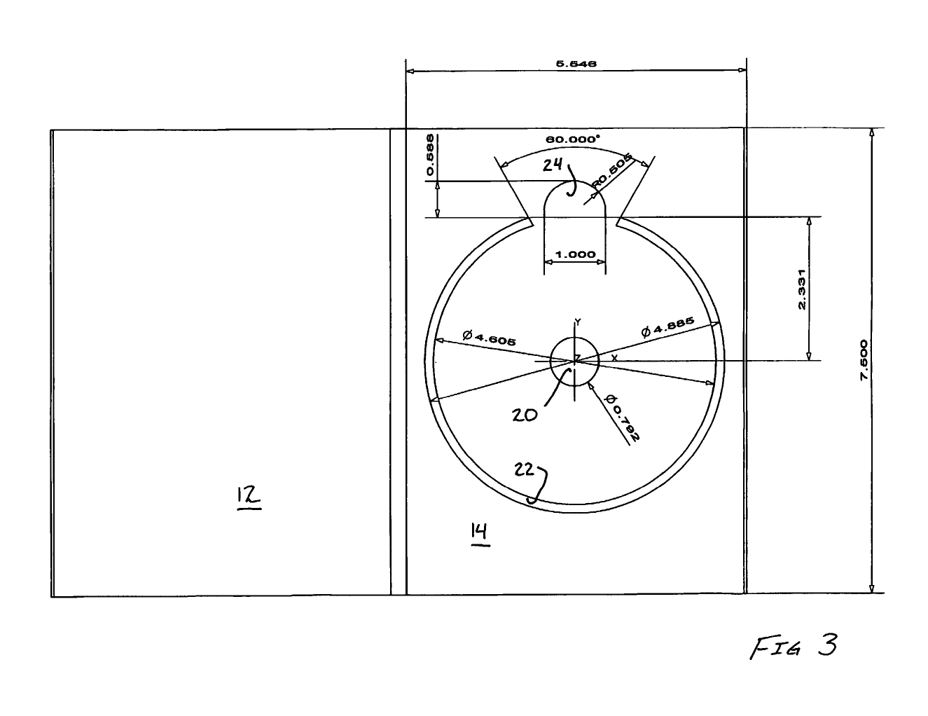

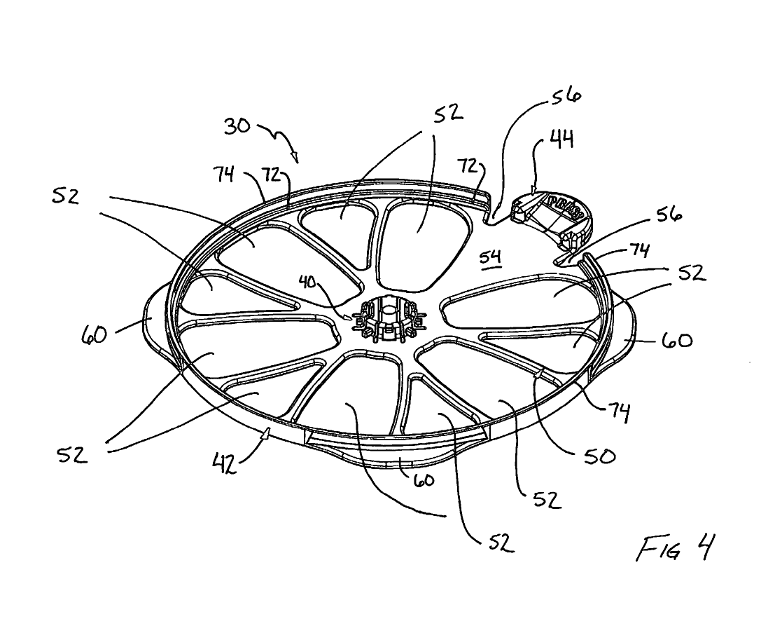

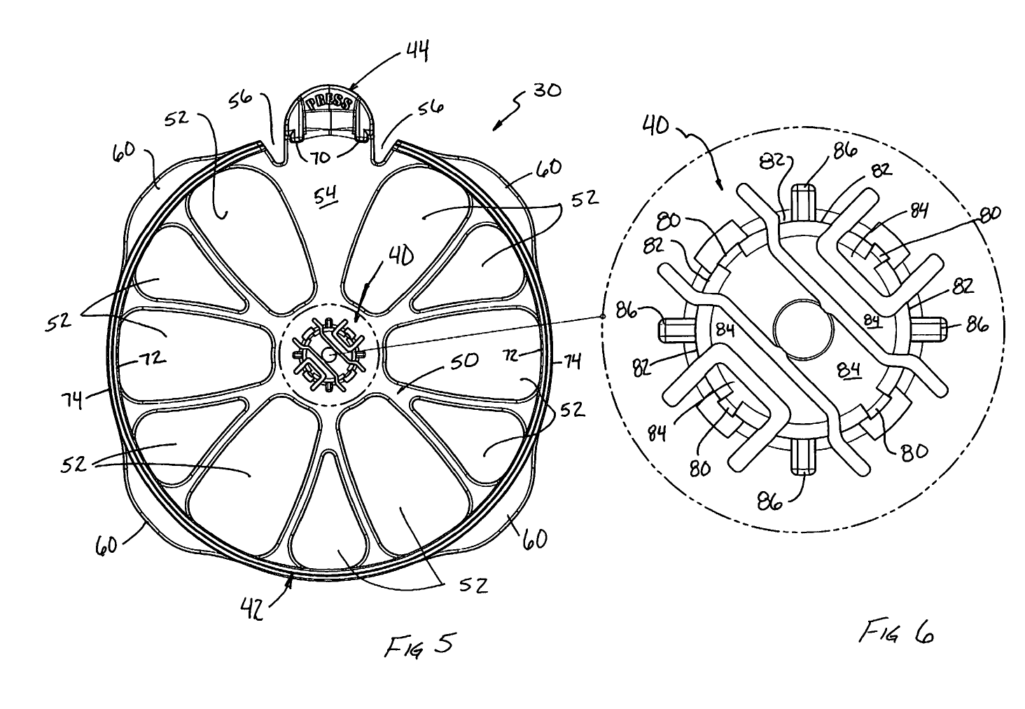

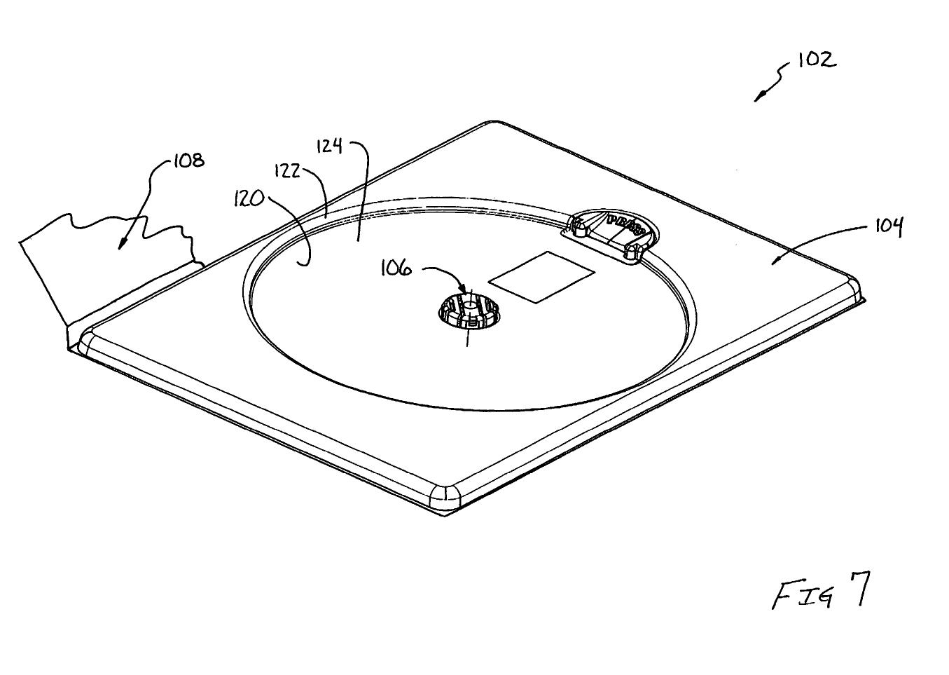

FIG. 3 depicts the openings 20, 22, and 24 that are defined by inner panel 14 through which portions of a holder 30 protrude to hold the item of merchandise within container 2. In the exemplary configuration of the invention, holder 30 is configuration to hold a media disc with a central hub 40, an outer nest wall 42, and an outer push tab 44. Opening 20 is sized to allow hub 40 to protrude through inner panel 14. Opening 22 allows the outer nest wall 42 to protrude through inner panel 14. Opening 24 allows push tab 44 to protrude through inner panel 14. The assembled configuration is depicted in FIG. 2 wherein the majority of the body of holder 30 is hidden from view. This configuration places a portion of inner panel 14 directly between the holder 30 and the disc that is held by holder 30. The nest of container 2 is thus disposed radially inwardly of wall 42 and above the upper surface of panel 14. Layering holder 30 and inner panel 14 in this manner requires hub 40, nest wall 42, and push tab 44 to be configured to accommodate the thickness of inner panel 14.

Holder 30 may be fabricated from plastic and may be injection molded. Holder 30 has a base wall 50 that defines a plurality of openings 52 that reduce the amount of plastic needed to form holder 30. Openings 52 are arranged to have no sharp corners and to define no straight arms that run entirely across base wall 50. Openings 52 alternate about hub 40 from large to medium. A medium opening 52 is removed to define a solid platform 54 disposed intermediate hub 40 and push tab 44. Base wall 50 defines a pair of notches 56 on either side of push tab 44 that allows push tab 44 to resiliently pivot down with respect to base wall 50. Notches 56 extend radially inwardly past outer nest wall 42.

Portions of base wall 50 are used to secure holder 30 to body 4. In the exemplary configuration, holder 30 defines four tabs 60 that are adhesively connected to the inner surface of base panel 10 and may optionally be adhesively connected to the inner surface of inner panel 14 when inner panel 14 is closed on holder 30 to trap holder 30 in place. Tabs 60 may be disposed in the same place as existing prior art adhesive connection points used with existing automated packaging equipment so that container 2 may be run through the existing automated packaging equipment. The adhesive allows holder 30 to be removed from body 4 to allow the individual portions of container 2 to be individually recycled after container 2 has been used. In another configuration, holder 30 may be configured with portions that snap over the outer surface of inner panel 14 to define a snap fit between holder 30 and inner panel 14 so that holder 30 may be connected without adhesive.

Push tab 44 has at least one locking finger 70 that is disposed over the top edge of a media disc when the disc is held on hub 40. Pushing down on tab 44 pivots finger 70 upwardly and away from the disc edge to allow the disc to be lifted away from container 2. The space below locking finger 70 is configured to receive a portion of inner panel 14 and the thickness of the media disc held by holder 30.

Outer nest wall 42 has a ledge 72 that has an inner wall that abuts inner panel 14. The outer edge of the disc may rest on the upper surface of ledge 72. Outer nest wall 42 further has an outer blocking wall 74 that prevents the user from accessing the outer edge of the media disc. This configuration ensures that the user may only access the media disc from a single location in container 2 at the location of push tab 44 which must be depressed in order to remove the media disc from container 2.

Hub 40 includes a plurality of projections 80 that are disposed over the inner edge of the media disc when the media disc is held on hub 40. No single projection 80 is purposely aligned with push tab 44 so that the inner surface of the media disc may slide along the sidewall 82 of hub 40 when the media disc is being removed from container 2. In the exemplary configuration of hub 40, four projections 80 are disposed at 90 degree angles about hub 40. Projections 80 are disposed 45 degrees to the location of push tab 44.

Hub 40 generally includes five hub portions that define the upper wall 84 and the sidewall 82 of hub 40. The five hub portions provide flexibility to hub 40 while prevent unintentional release of the media disc. Hub 40 includes a plurality of feet 86 disposed between sidewall 82 and base wall 50 of holder 30. Feet 86 support the lower surface of the media disc and help locate hub 40 within opening 20.

Two projections 80 are disposed on independent hub portions (the first and fifth hub portions that are disposed on opposite sides of the hub). The projections are relatively flexible because of the configuration of the first and fifth hub portions. The remaining two projections 80 are disposed on a common hub portion (the central third portion) and are thus relatively stiff. This combination of the flexible projections 80 and the stiff projections 80 cooperate to retain the media disc in a relatively secure manner. The hub is not a push button-type hub such that pressing one's thumb on the top of hub 40 does not automatically release the disc or significantly move projections 80. The sidewall portion 82 of the second or fourth hub portion (that faces push tab 44) provides the smooth surface for the inner surface of the media disc to ride up as it is being removed from hub 40.

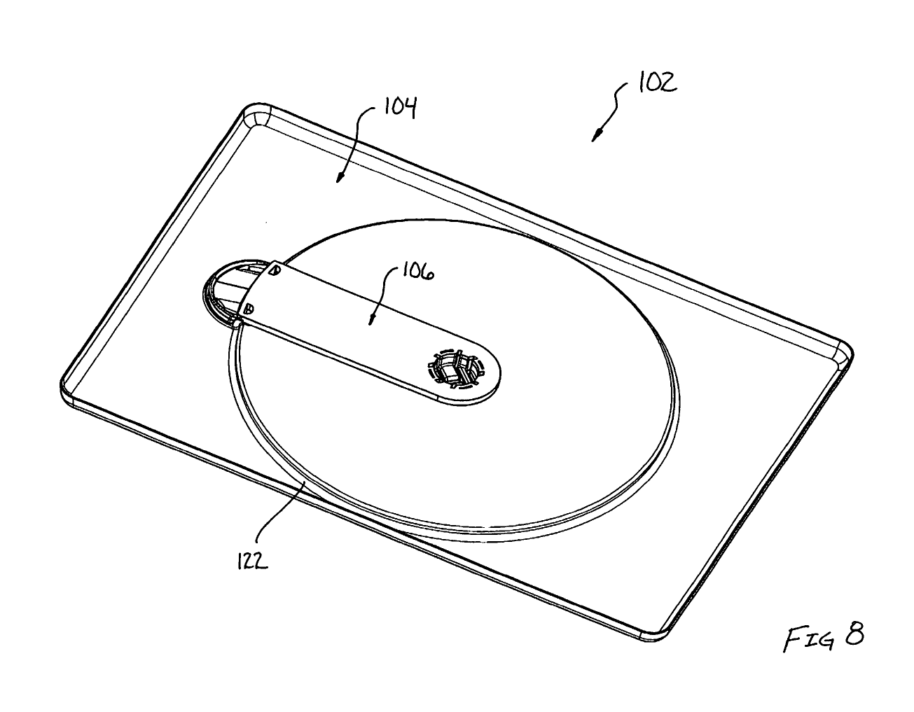

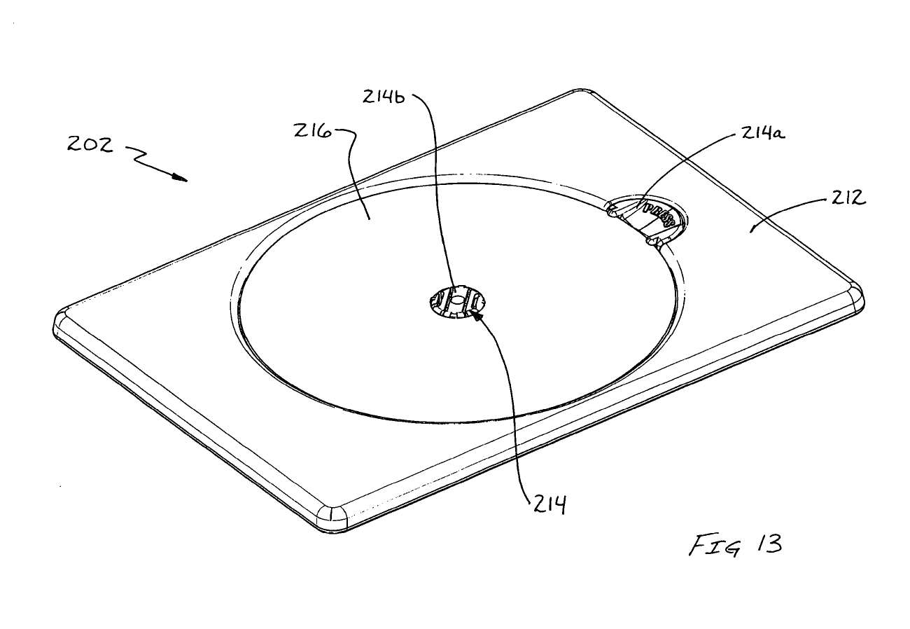

A second configuration of the container is indicated generally by the numeral 102 if FIGS. 7-12. Container 102 generally includes a container body 104 that is connected to a merchandise holder 106. Container 102 may include additional features such as a cover 108 that may be in the form of a folding book-like cover 106 as shown in FIG. 7 or as a five-sided sleeve that slidably receives container 102 between open and closed positions. Alternatively, container 102 may be used with other container configurations or combined with other features to form a final consumer product. In another example, container 102 may be shrink-wrapped to define the product that is delivered to the consumer.

Container body 104 may be provided in a variety of shapes and sizes depending on the nature of the merchandise to be carried by container body 104. In the exemplary configuration, container body 104 is rectangular in shape and has a pair of side walls, a top wall, and a bottom wall that define an outer rim about the perimeter of body 104. Body 104 may be provided in the same length and width as a standard DVD container which is 135 mm×190 mm. The front surface of body 104 may be flat and continuous except where indented to define a nest 120 sized to receive a media disc such as a CD or DVD (nest diameter is greater than 120 mm), or other sized-media disc. The rear surface of body 104 may be indented to complement the front surface in order to reduce the amount of material that is used to form body 104. In other configurations, body 104 may be solid with areas removed for nest 120 and holder 106.

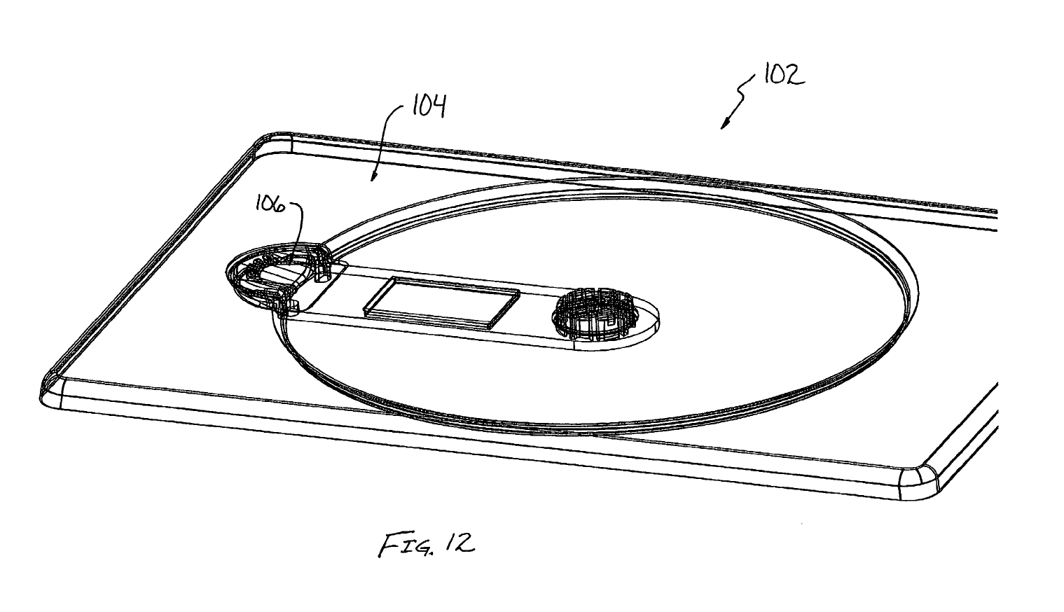

Nest 120 is defined by at its outer periphery by a nest sidewall 122 and at its lower extents by a nest bottom wall 124. Nest wall 122 may be continuous about the entire perimeter of nest 120 or may define one or more openings 126 to provide spaces for portions of holder 106 to protrude through body 104. Similarly, nest bottom wall 124 may be continuous or may define one or more openings 126 that provide spaces for portions of holder 106 to protrude through body 104. Openings 126 are shown in FIG. 11. Nest side wall 122 and nest bottom wall 124 also may be formed to have features that cooperate with holder 106 to retain the item of merchandise in container 102.

Holder 106 is configured to securely retain the item of merchandise for which container 102 is to be used. In this example, holder 106 is configured to retain a media disc and thus includes at least a disc retaining hub 40 configured to be disposed through the central opening of a media disc to securely retain the disc. Hub 40 may have the structure described above or another structure suitable for holding a media disc. Holder 106 also may include a push tab 44 disposed in opening 126 at sidewall 122. Push tab 44 may have the structure described above or an alternative structure suitable for helping to secure the disc. In another configuration, container 102 may use hub 40 without push tab 44. In such a configuration, nest sidewall 122 may define a finger access opening or finger access indentation that allows the user to access the outer edge of the media disc when the disc is being removed from the container. In another configuration, container 102 may use a plurality of push tabs 44 or a single push tab 44 combined with another feature for securing the media disc at the outer perimeter of the disc. Such a configuration may not use central hub 40.

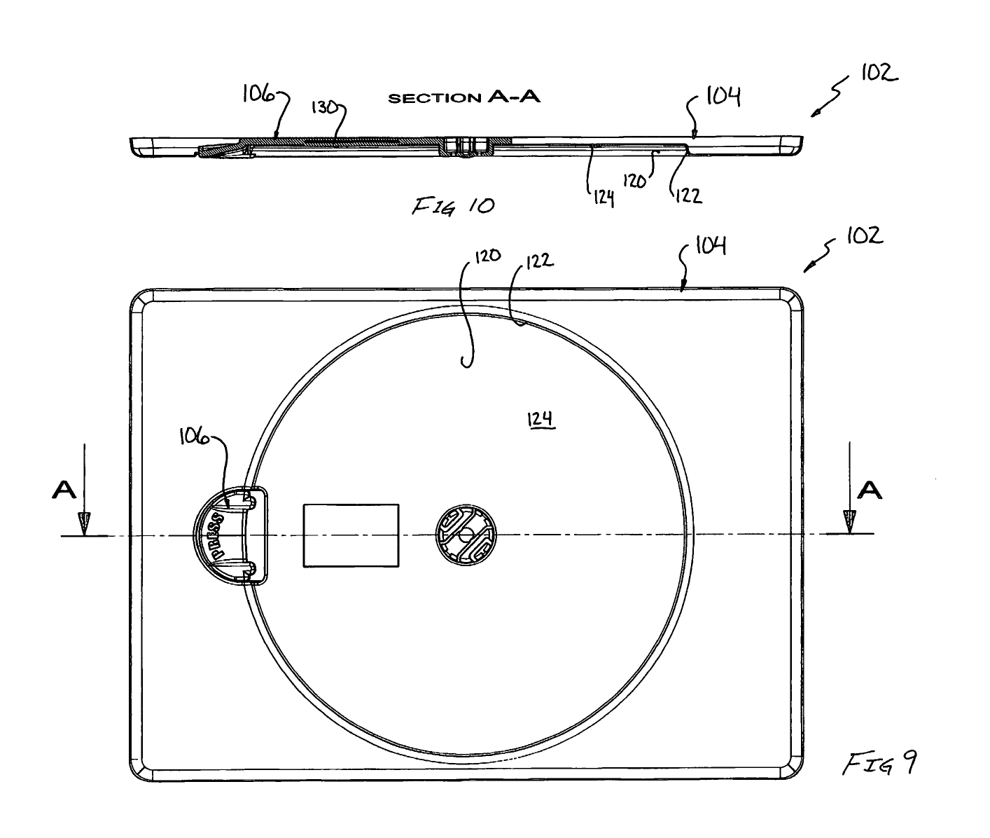

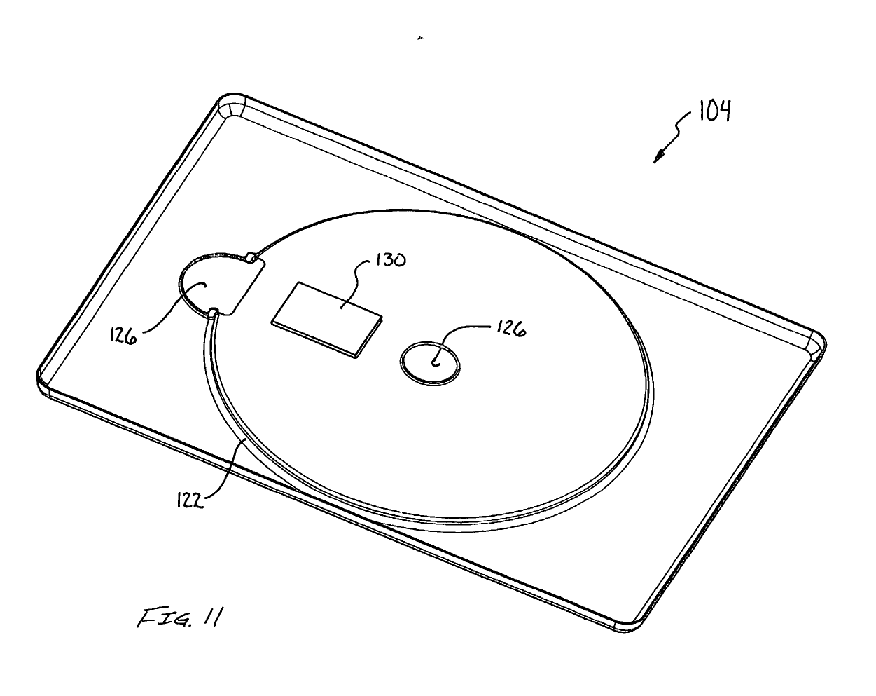

FIG. 10 shows that the overall thickness of container body 104 is sufficient to receive holder 106 such that holder 106 does not protrude beyond the lower boundaries of container body 104. Container body 104 will thus rest squarely on the bottom surface of its outer walls when placed on a flat surface. The bottom surface of holder 106 may be co-planar with the bottom edges of body 104 so that container 102 also rests on holder 106 when placed on a flat surface. This configuration provides support to hub 40 and push tab 44 when the user presses down on these elements. When container body 104 is to be used with another container feature such as a cover, container body 104 may define a plurality of surfaces that receive adhesive to allow it to be adhesively secured to the additional cover feature. Similarly, mechanical connectors or features adapted to receive mechanical features also may be provided by container body 104.

Container body 104 is fabricated separate from holder 106. Container body 104 may be made from a relatively inexpensive recycled product that does not have to be as robust as the material used to form holder 106 because container body 104 is not primarily responsible for retaining the item of merchandise with container 102. Container body 102 may be made from virgin plastics and/or recycled plastics such as polyethylenes (PE, PET, PETE, HDPE), polypropylene, polystyrene, other recycled plastics, or paper-based, starch-based, or fiber-based moldable materials such as those sold under the registered trademark PAPERFOAM®.

Holder 106 may be fabricated from a material that is desirable for disc hubs 40 and push tabs 44. Such materials include polypropylene, styrene, ABS, and other materials that are known to be used for disc hubs that are subjected to repeated bending forces. Hubs 40 are typically injection molded. Container 102 may be manufactured by molding holder 106 directly to container body 104 such that an adhesive or separate mechanical connectors are not need to form the secure connection between holder 106 and body 104. In this process, body 104 is placed in the mold for holder 106 and holder 106 is molded onto, through, or around body 104. In order to provide a secure connection between holder 106 and container body 104, body 104 may include one or more pedestals 130 that define overhangs around which a portion or portions of holder 106 are molded such that a portion of the material that forms holder 106 is disposed under the overhang. When holder 106 cools, a secure mechanical interlock is formed between the two elements to secure holder 106 to body 104. Molding holder 106 in this manner eliminates the need to manually connect the two elements after both are formed.

In the exemplary configuration, pedestal 130 is rectangular and provides four overhanging edges to receive the material that forms holder 106. Pedestal may be located intermediate hub 44 and push tab 44. In some combinations of materials, the material of holder 106 may bond directly to the material of container along the underside of body 104 to form another connection between holder 106 and body 104.

In another configuration of container 2, holder 106 is formed separately from container body 104 and then connected to container body 104 with an adhesive or with mechanical connectors.

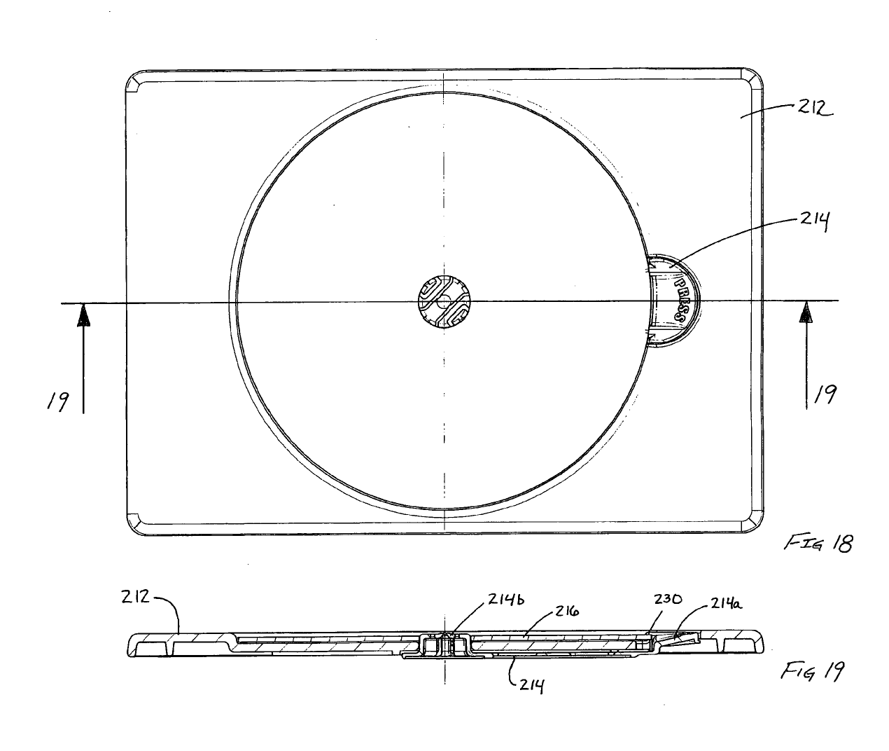

A third configuration of the container is indicated generally by the numeral 202 in FIGS. 13-19. In the exemplary configuration, container 202 is depicted in the form of a tray 212. Tray 212 may be connected to a cover or a device that includes other trays 212. Tray 212 may be used alone and shrink-wrapped. The tray body 212 is preferable made of biodegradable material, preferably a starch-based material. In particular, tray 212 is made of a material based on a starch that is derived from potatoes. However, any suitable biodegradable or recyclable material (such as a recyclable plastic or paper-based material) may be used. As illustrated, an item of merchandise such as a media disc 216 is held in place on tray 212. A holder 214 is used to hold media disc 216 in tray 212. Holder 214 preferably includes an outer push tab 214a and a central hub portion 214b. Outer push tab 214a preferably includes a securing lip or locking finger 230 that extends over an outer periphery of the optical disc 216 when it is in nest 212b.

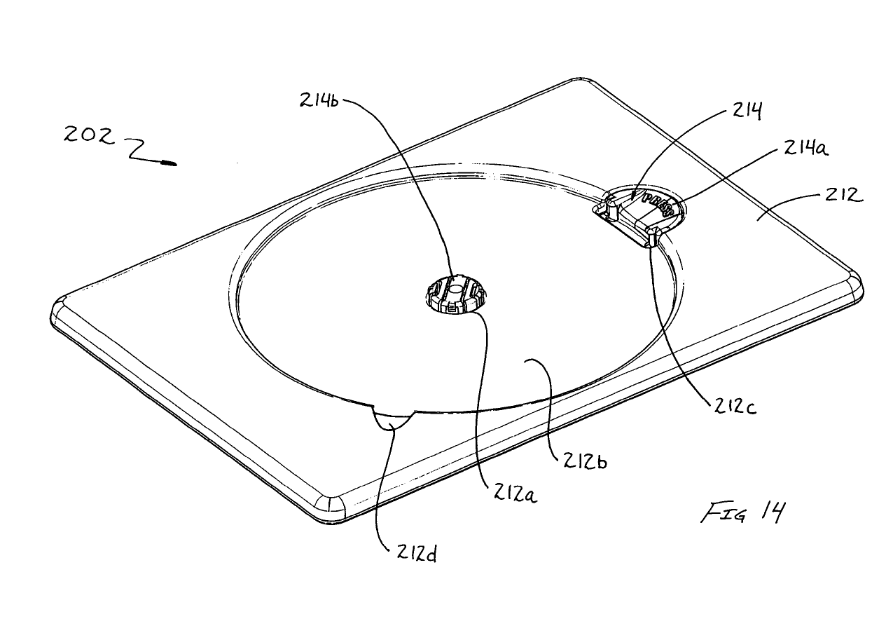

FIG. 14 illustrates the body of tray 212 in more detail. As illustrated in FIG. 14, central hub portion 214b of holder 214 extends up through an opening 212a formed in the tray body 212. More specifically, the opening 212a is formed in a center of a receiving area or nest 212b of tray 212. Nest 212b is the area in which the merchandise is received on tray 212. Outer push tab 214a extends up through a peripheral opening 212c formed on a periphery of nest 212b. Tray 212 may include optional release depressions 212d (shown only as an option in FIG. 14) located around the periphery of nest 212b. These depressions 212d aid users in removing optical disc 216 received in nest 212b by allowing a point of access for the user to touch the edges of media disc 216.

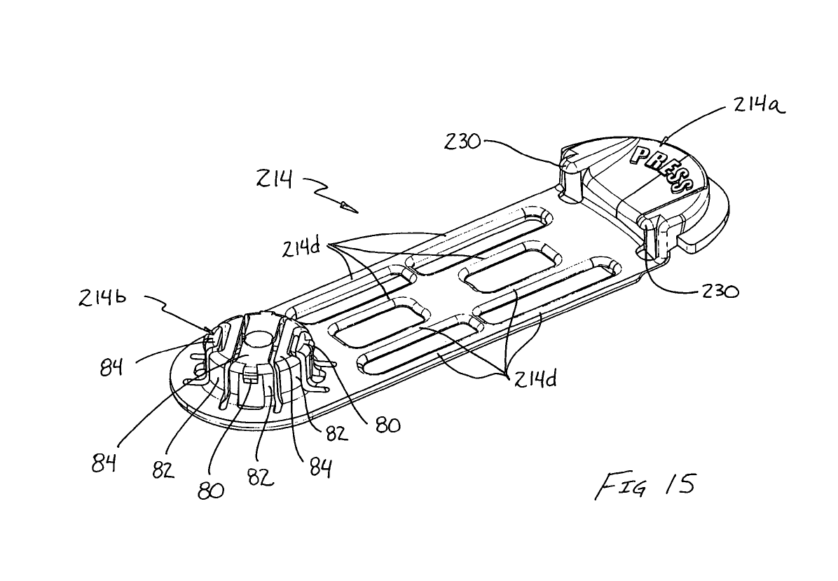

FIG. 15 is a more detailed illustration of holder 214. Holder 214 is preferably made of plastic. The plastic is preferably recyclable. In one embodiment, the plastic may include a newly available biodegradable additive that has recently been introduced to the market. In either case, the amount of plastic used is relatively small and, as noted above, is either recyclable or biodegradable such that the hub structure 214 has minimum adverse affect on the environment and weight of the overall tray.

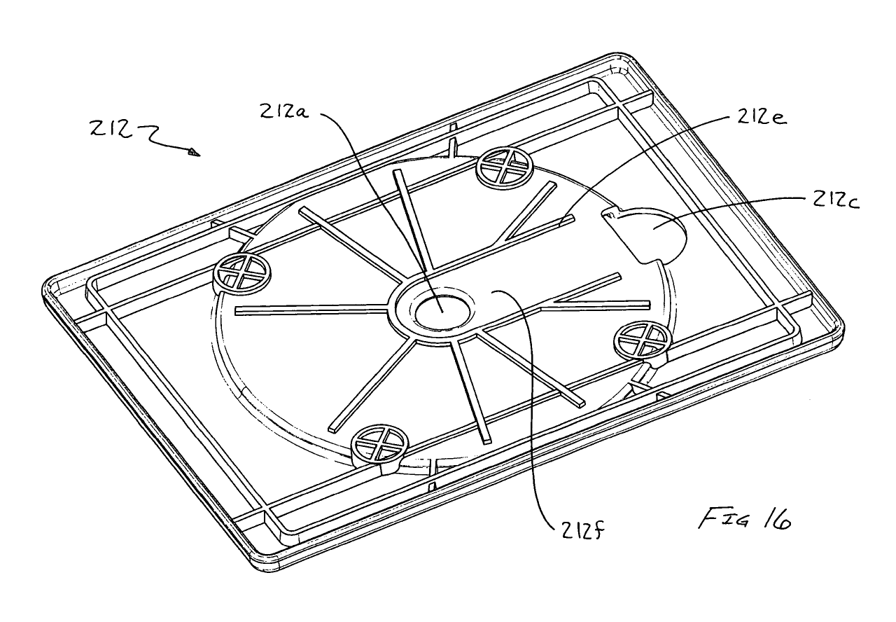

As illustrated, outer push tab 214a is preferably connected to the central hub portion 214b via a plurality of spaced connecting elements 214d rather than as a larger single piece. The entire width of holder 214 is no greater than the width of outer push tab 214a. This configuration minimizes plastic use. When holder 214 is attached to tray 212, connecting elements 214d may be either embedded in the tray body 212 or embedded in a cardboard sleeve on which tray 212 is mounted. Alternatively, connecting elements 214d may be embedded both in tray 212 and on the cardboard sleeve. In the configuration depicted in FIGS. 15-16, holder 214 defines a snap fit surface 214e about a portion of its outer periphery that cooperates with a retainer 212e disposed on the bottom of tray 212 to secure holder 214 to tray 212. The snap fit connection may be used alone or in combination with an adhesive. Alternatively, an adhesive may be used to secure the two elements (212 and 214) together without any mechanical connectors. FIG. 16 illustrates a rear side of tray 212. As illustrated, the rear side of tray 212 includes a slot 212f in which holder 214 is received. Slot 212f may be recessed into the body of tray 212 or defined by walls as shown in FIG. 16.

The central hub portion 214b preferably includes one or more projections 80 extending out over the inner edge of the center opening in the media 216 as described above. The primary force used to hold the media in place is applied at the periphery of the media at the release portion 214a, in contrast to most conventional trays. Since the hub structure 214 is preferably made of plastic, it is durable and flexible to reliably hold the media 216 in place.

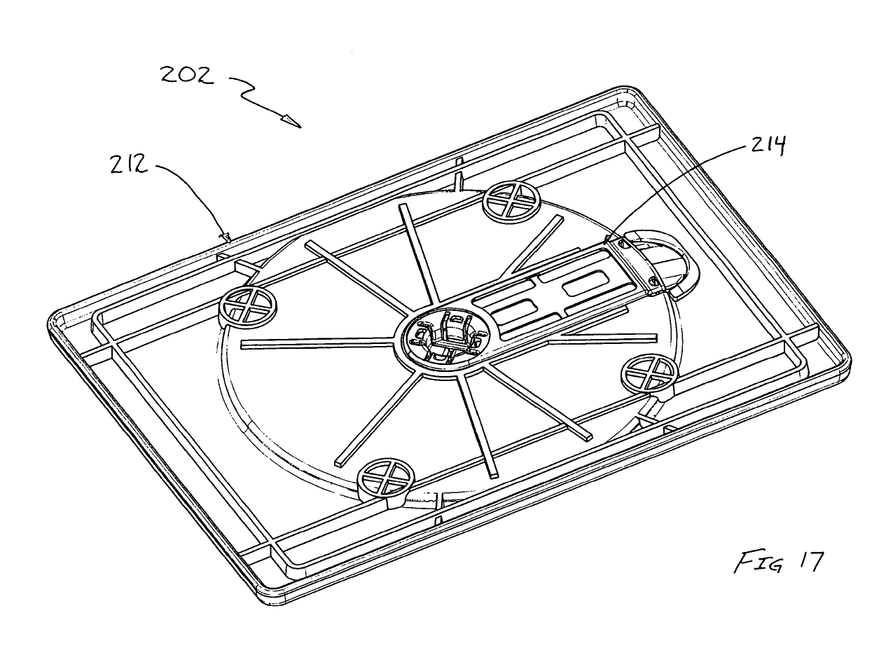

FIG. 17 illustrates holder 214 positioned in slot 212f. Outer push tab 214a is preferably structured to flex somewhat relative to the rest of holder 214 so that holder 214 may be readily installed onto tray 212 and so that disc 216 may be removed.

FIG. 19 illustrates a detailed cross section of a portion of tray 212 with the media 216 mounted therein. As illustrated, locking finger 230 of outer push tab 214a holds the periphery of the media 216 in place while projections 80 of central hub portion 214b secure the center of the media 216. To remove the media 216, pressure is applied to outer push tab 214a to cause it to flex down such that locking fingers 230 are moved away from the periphery of media disc 16 to allow it to be removed easily from tray 212. Projections 80 are flexible and allow disc 216 to be removed as well. In addition, or in the alternative, disc 216 may be removed from tray 212 by applying pressure at any of the release depressions 212d located around the periphery of nest 212b. That is, locking fingers 230 are sufficiently flexible to allow media disc 216 to be removed if sufficient upward force in applied via one of the release depressions 212d.

Thus, container 202 of the present application includes both biodegradable material and some plastic material for those elements that require durability and resilience. Specifically, the hub structure 214 is made of plastic such that it provides a durable and reliable means for holding the media in place even during shipping. However, since the amount of plastic that is used in minimized and the plastic itself may be biodegradable, the overall negative affect of the tray 10 on the environment is minimized.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A storage container for a media disc; the container comprising:
a container body made from a first recyclable material;
the container body defining a nest having an outer periphery; the nest defining a first central opening and a second peripheral opening;
a holder having a disc retaining hub adapted to be received in a center opening of a media disc; the holder also having an outer push tab adapted to engage an outer edge of the media disc; and
the disc retaining hub protruding through the first central opening of the nest and the outer push tab protruding through the second peripheral opening of the nest.

2. The container of claim 1, wherein the holder is connected to the tray with an adhesive.

3. The container of claim 1, further comprising a pedestal projecting from the container body; the holder being secured to the container body with the pedestal.

4. The container of claim 3, wherein the pedestal defines an overhang; the holder surrounding the overhang.

5. The container of claim 4, wherein the pedestal is disposed intermediate the disc retaining hub and the outer push tab.

6. The container of claim 1, wherein a lower surface of the holder is disposed above or even with a lower surface of the container body.

7. The container of claim 1, wherein the outer push tab includes at least one locking finger adapted to be disposed over the top of the media disc when the media disc is disposed on the disc retaining hub.

8. The container of claim 1, wherein the first recyclable material is one of a moldable starch-based material and a moldable pulp-based material.

9. A merchandise storage container comprising:
a merchandise holder and a container body;
the container body having an upper surface and a lower surface;
the container body defining at least a portion of a merchandise nest and a first opening disposed in the nest;
the merchandise holder being fabricated from a first plastic material and the container body being fabricated from a second recyclable material; and
a first portion of the merchandise holder protruding through the first opening defined by the container body; the first portion of the merchandise holder being adapted to retain an item of merchandise with a portion of the nest of the container body disposed between the merchandise holder and the merchandise.

10. The container of claim 9, wherein the container body defines a second opening and the merchandise holder defines an outer nest wall that protrudes through the second opening to define the merchandise nest inwardly of the outer nest wall and above the upper surface of the container body.

11. The container of claim 10, wherein the second opening substantially surrounds the first opening.

12. The container of claim 11, wherein the container body defines a third opening; a second portion of the merchandise holder protruding through the third opening; the second portion of the merchandise holder being an outer push button adapted to engage the merchandise.

13. The container of claim 9, wherein the merchandise holder is mechanically interlocked with the container body.

14. The container of claim 9, wherein the container body defines a pocket; the merchandise holder being disposed in the pocket.

15. A method of making a merchandise holder comprising the steps of:
manufacturing a container body from a first material wherein the container body is molded to have a first portion of an interlock; and
molding a merchandise holder from a second material directly to the container body with a portion of the merchandise holder engaging the first portion of the interlock to secure the merchandise holder to the container body.

16. The method of claim 15, wherein the container body includes a pedestal and further comprising the step of molding the holder around the pedestal to form an interlock between the holder and the body.

17. The method of claim 16, further comprising the step of molding the holder to have a portion that extends through the container body.
